(19) United States
(12) Patent Application Publication
(10) Pub. No.: US 2008/0124438 A1
(43) Pub. Date: May 29, 2008

(54) Fryer basket

(76) Inventors: Melissa Forte, Revere, MA (US); Timothy Bragg, Woburn, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/604,656

(22) Filed: Nov. 27, 2006

(51) Int. Cl. A47J 37/12; B65D 6/08; A23L 1/01

(52) U.S. Cl. 426/389; 220/494; 99/407

(57) ABSTRACT

The apparatus includes a basket body, a basket door with a pivoting mechanism for attaching the door to a bottom portion of the basket body and a basket slider connected to the basket door. The basket door is pivotal between an open position and a closed position. The apparatus also includes a handle with a handle housing and comprising a trigger member in the handle housing. The trigger member has a pivot end in the slot in the opposite end. The apparatus also has a basket drive rod with a first end and a second end. The first end connects to the basket slider and the second end slidably engages the slot of the trigger member. In operation, pivoting of the trigger member about the trigger pivot and translates the basket drive rod with a translation moving the basket slider. The basket slider moves the basket door between an opened and a closed position.

### BACKGROUND

Typically in the restaurant and the hospitality arena several different types of food can be sold exclusively for cooking in deep fat fryers. These deep fat fryers are commercially used by restaurants, institutional kitchens, and fast food establishments for cooking.

These foods may include a variety of food products, such as French fries, fish, fried chicken and other similar fried foods. As is known, food products are cooked by inserting them into a fryer basket and immersing the basket in a fryer vat that is filled with a heated liquid cooking medium such as lard, shortening, oil or another type of material. Typically, the lard or oil temperature is kept at a cooking temperature such as 250° F.

The known fryer basket typically includes a handle and a basket body made from steel or other resilient lightweight material in a mesh configuration. The basket is left into the deep fat fryer in order to cook the food for a period such as three to five minutes. Thereafter, the basket is removed using the handle. Excess oil is allowed to drain through the mesh basket body.

Often, an operator may find it desirable to shake the container a number of times over the fryer after removing the basket to remove residual cooking grease droplets from lateral surfaces of the fryer basket. To remove the cooked foods from fryer basket, typically requires the operator to rotate the fryer basket about 180° to eject the cooked food through the opening at the top side of the basket.

### SUMMARY

It is difficult, depending on the food that is being cooked (which may involve several small food pieces, such as French fries), to project the food into a predetermined or desired spot using known fryer basket methods. By rotating the deep fryer basket to place the food on a plate, one can often miss the plate and unintentionally place the food on a counter or on the floor. Moreover, often the chef cannot touch the hot basket to properly orient the basket.

Moreover, such methods and apparatus of the prior art are not advantageous, since they require shaking to eject the food once the basket is rotated. Further, the operator cannot control how fast or how slow the food is released from the deep fryer basket, since often the French fries or other food will tumble out uncontrollably. Moreover, the known method of releasing the food from the deep fryer basket can also allow excess grease or oil deposited on the sidewalls of the basket to contact the food upon the rotation, or instead the grease may contact a plate or floor.

Accordingly, there is a need in the art for a fryer basket that does not require rotating or shaking the basket in order to release the cooked contents from the fryer basket. There is also a further need for a fryer basket that allows an operator to precisely place and eject the food in a controlled manner. There is also a further need for a fryer basket that allows an operator to eject the food quickly from the bottom of the fryer basket and then return the fryer basket to a stowed location over the fryer in order to avoid any stray messy grease droplets from falling on a plate, or on the floor which require clean up, or may present a potentially hazardous condition.

In an embodiment, the apparatus comprises a basket body and a basket door having a pivot mechanism for attaching the door to a bottom portion of the basket body. The basket door is pivotal between an open and closed position. The apparatus further includes a basket slider connected to the basket door and a handle with a handle housing.

The handle housing includes a trigger member in the handle housing. The trigger member has a pivot end and a slot in an opposite end. The apparatus further includes a basket drive rod having a first and a second end, with the first end connecting to the basket slider and the second end slidably engaging the slot of the trigger member. In operation, pivoting of the trigger member about the trigger pivot end translates the basket drive rod with a translation moving the basket slider. The basket slider moves the basket door between an open position and a closed position.

According to a further aspect of the present invention, the apparatus further includes a second basket door. The second basket door has a pivoting mechanism for attaching the second basket door to a bottom portion of the basket body. The second basket door is pivotal between the open position and the closed position.

In another aspect, the basket slider further comprises at least two fingers at the second end of the basket drive rod. At least two fingers move the respective basket doors between the open position and the closed positions.

In another aspect, the trigger member further comprises a hook. The hook is configured to detachably connect with a handle housing at the slot end. According to a further aspect, the apparatus includes a basket door that has a looped ring. The looped ring is configured to engage an aperture in the basket slider. When the basket slider is translated upward or downward, the looped ring that is connected to the basket slider through the aperture is translated upward or downward to rotate the basket door about the pivoting mechanism to close or open the basket door respectively.

According to a further aspect, the apparatus further comprises a second basket door. The second basket door comprises a second loop ring that is configured to engage a second aperture in the basket slider. When the basket slider is translated upward or downward, the second loop ring connected to the basket slider through the second aperture is translated upward or downward. This rotates the second basket door about a pivot mechanism to close or open the second basket door.

According to another aspect, the basket door is generally rectangular shaped or is generally circular shaped. In another aspect, the apparatus is configured so that if the hook is detached then the hook is adapted to release the trigger member from the handle housing to allow the trigger member to move about the trigger pivot end.

In a further aspect, the trigger member has a bottom surface that extends through a bottom portion of a handle housing. When the hook detaches from a handle housing, the bottom surface is configured as a palm support surface. This provides support and is configured to also support the trigger member an amount so as to permit the user to control the pivoting of the trigger member about the trigger pivot end.

According to a further aspect, the apparatus further comprises a spring. The spring biases the trigger member relative to the handle housing.

According to yet a further aspect, the apparatus further comprises an elongated member connecting the handle housing and the basket body.

In another embodiment, an apparatus has a basket body and a first basket door. The door has a first pivot mechanism for attaching the first basket door to a bottom portion of the basket body. The first basket door is pivotal between an open and a closed position.

In another embodiment, an apparatus has a basket body. The first and second basket doors can be made from the same material. Additionally, at least one of the basket body and the first and second basket doors can be made from a mesh material.

In another embodiment, an apparatus includes a basket body and a basket door with a pivot mechanism for attaching the door to a bottom portion of the basket body. The basket door pivots between an open position and a closed position. The apparatus further includes a handle with a device for opening and closing the basket door.

According to yet another embodiment a method for cooking that includes inserting food into a basket and inserting the basket into heated oil in a deep fat fryer to cook the food. The method also includes lifting the basket from the heated oil, and without rotating the basket, ejecting the cooked food from the basket bottom. In yet another aspect, the apparatus may be used for either residential use or commercial use.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a perspective view of an embodiment of a fryer basket having a pair of basket doors shown in a closed position.

FIG. 2 is a perspective view of the fryer basket of FIG. 1 with the door between the open and closed positions.

FIG. 3 is a perspective view of the fryer basket of FIG. 1 with the doors in an open position.

FIG. 4 is an exploded view of the fryer basket of FIG. 1 showing a number of components thereof.

FIGS. 5A through 5D show operation of a trigger handle of FIG. 1.

FIGS. 6A through 6C are side views of the fryer basket corresponding to FIGS. 1 through 3 showing operation of the basket slider and fingers to open the basket doors.

### DETAILED DESCRIPTION

A description of example embodiments of the invention follows.

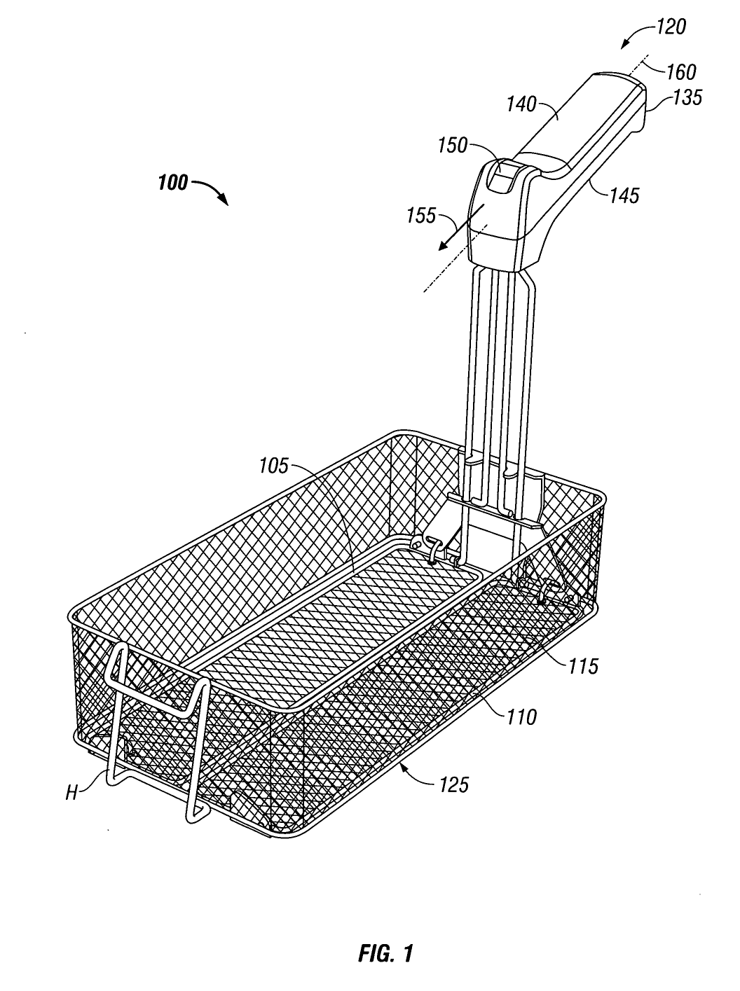

Turning now to FIG. 1, there is shown a first embodiment of a fryer basket 100 of the present disclosure in a perspective view. The fryer basket 100 preferably has a first door 105 and a second door 110. The doors 105, 1105 generally are made as a metal mesh structure to allow grease and oil to easily traverse the basket. Both doors 105, 110 are located on a bottom portion of a basket 115. The basket 115 is operatively connected to a handle 120. The user can hold the handle 120 and then selectively open the basket 115 using the handle 120. The basket 115 opens from a bottom portion 125 to release the fried food contents disposed in the basket 115 on to a desired location such as a plate, tray, or serving basket. The basket 115 also includes an exterior hook H. Exterior hook H is positioned on the basket 115 to permit the basket 115 to be temporarily supported on a cooking appliance (not shown).

Advantageously, using the handle 120 the user can also control how quickly or slowly the first door 105 and the second door 110 open or close. These features are advantageous since the fryer basket 100 avoids the conventional manner of emptying the contents by rotating the fryer basket to empty the contents from a top opening. This rotation may lead to the food tumbling and missing the desired location on a serving plate. Instead, the food may land on a counter which unintentionally contaminates the food.

With the present approach, the fryer basket 100 provides for controlled and accurate release of the food onto the plate or desired location using the handle 120. Moreover, the fryer basket 100 may allow the fried food to rest over the deep fat fryer to drain excess oil and grease from the food, and then provide for a quick and accurate release of the food onto the plate. This quick release feature avoids turning the entire fryer upside down which may lead to further excess grease from a top opening or lateral sides of the basket 115 to escape and touch the food, floor or plate during transfer.

The handle 120 includes a housing 135 with a top side 140 and a bottom side 145. The top side 140 includes a hook member 150. The hook member 150 preferably engages with a portion of the handle housing 135 to support the first and the second door 105, 110 in the configuration shown in FIG. 1 using a support which is described in detail further herein. Using an index finger or thumb, the user may move the hook member 150 in a direction parallel to a horizontal axis 160 of the housing 135 as shown by arrow 155. This movement releases or otherwise detaches the hook member 150 from the handle housing 135 resulting in the opening of the first and the second basket doors 105, 110. It should be appreciated that the embodiments may actuate the handle 120 differently to open doors 105, 110. For example, the fryer basket 100 may include a switch or button located in other areas or on the handle 120.

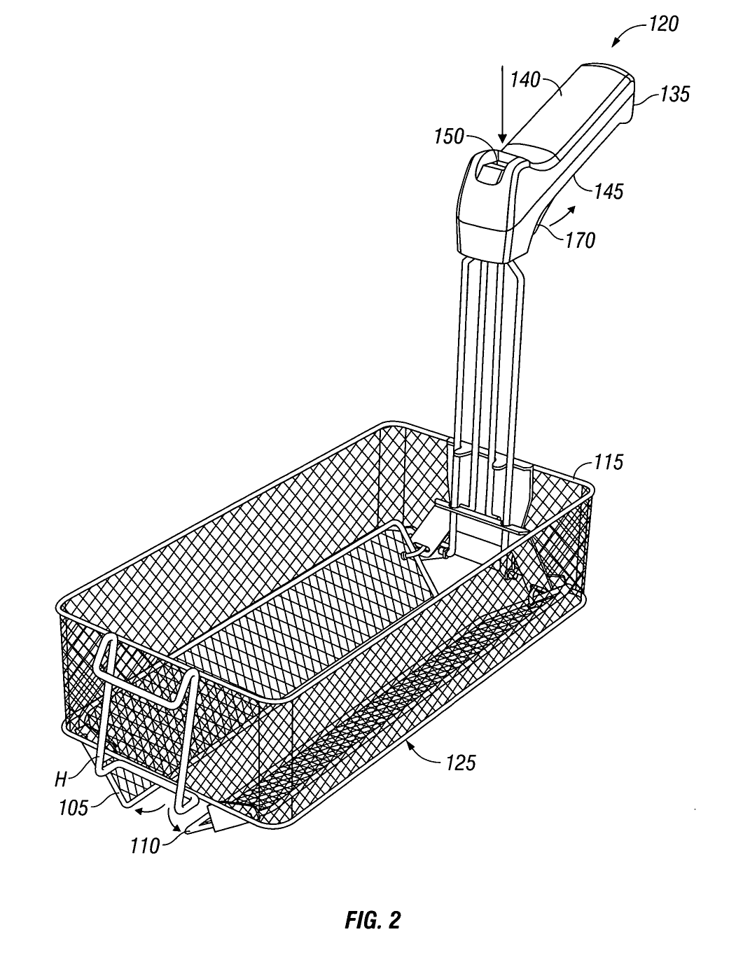

Turning now to FIG. 2, the fryer basket 100 has, on a bottom side 145 of the handle housing 135, a support surface 170 that may be supported using the palm of the user. In this manner, the user may squeeze the handle housing 135 and support surface 170 to control the opening of first and the second doors 105, 110. If the support 170 is held in a direction toward the handle housing 135, the basket doors 105, 110, will be prevented from opening.

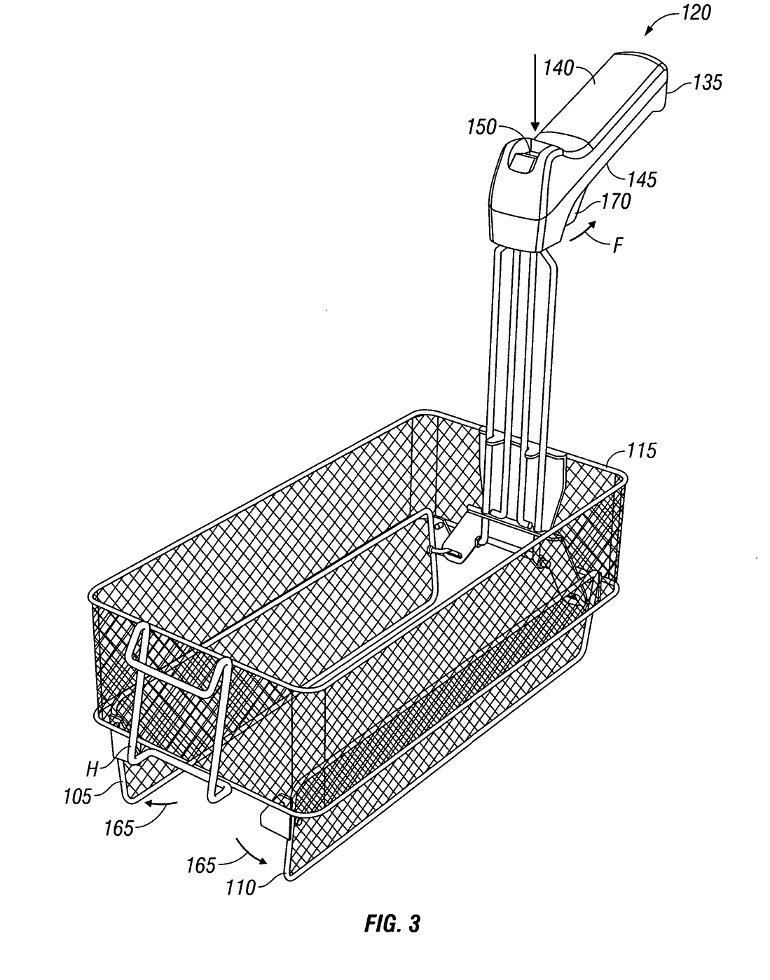

Turning now to FIG. 3, there is shown the doors 105, 110 opened in a direction illustrated by reference arrows 165. Here, if the support surface 170 is gently released or released slowly as shown by reference arrow F, then the doors 105, 110 will completely open as shown by reference arrows 165. Operation of the above assemblies is described in detail further herein.

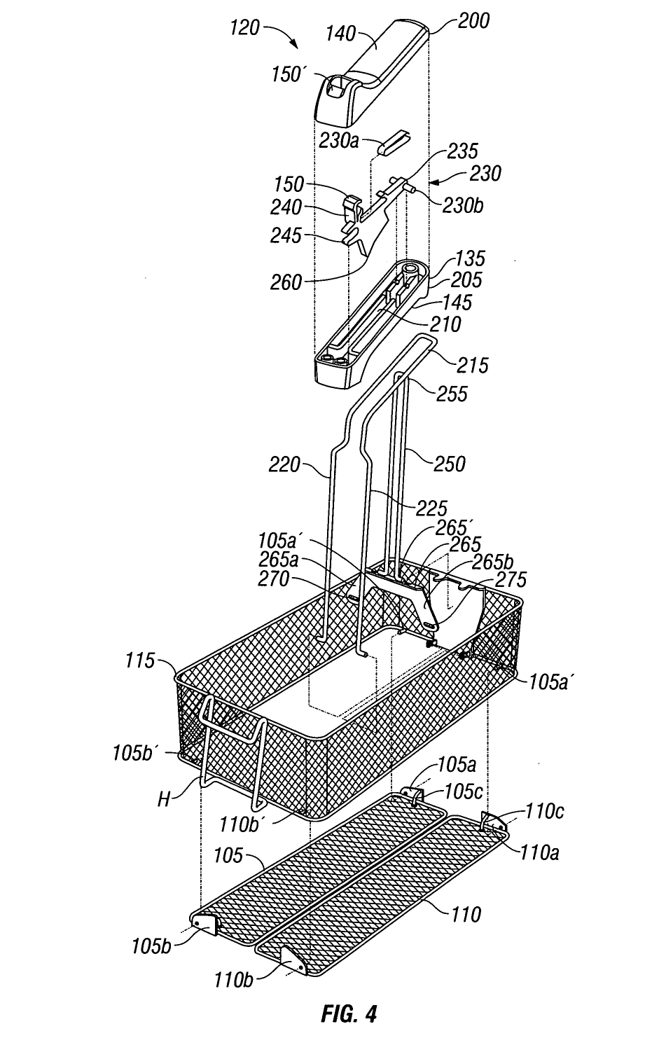

Turning now to FIG. 4, there is shown an exploded view of the fryer basket 100. The fryer basket 100 includes a handle assembly 120 that includes a first handle housing portion 200 and a second handle housing portion 205. The second handle housing portion 205 includes a channel 210 disposed therethrough. The channel 210 is generally orthogonal relative to the housing portion 205 and extends along a length of portion 205.

A wire handle portion 215 is disposed on a bottom side of the second handle housing portion 205 and is secured thereto. The wire handle portion 215 and the second housing portion 205 may be connected to one another using any fasteners, screws or bolts as is known in the art. On an opposite end, the wire handle portion 215 includes prongs 220, 225 that are fixedly connected to the basket 115. The wire handle portion 215 preferably connects the basket 115 to the second handle housing portion 205 of the handle 120. In an alternative embodiment, the basket 115 may be directly connected to the second handle housing portion 205, and instead of being connected using the wire handle portion 215.

Disposed in the handle assembly 120 is a trigger member 230. The trigger member 230 is disposed between the first handle housing portion 200 and the second handle housing portion 205. The trigger member 230 is a structure which will translate a downward motion or an upward motion from the handle 120 to ultimately open or close the basket doors 105, 110. A portion of the trigger member 230 is positioned in or through the channel 210 that is disposed through portion 205. The trigger member 230 may be biased against the first housing handle portion 200 by a spring 230a and may move in the handle 120 about a point. In this regard, the trigger member 230 has a pivot 230b disposed at a pivot end 235. The trigger member 230 also has an opposite end 240. Pivot 230b engages a complementary structure in the second housing handle portion 205 and remains fixed in the handle 120 so only end 240 may move upwardly or downwardly.

The end 240 of the trigger member 230 includes a slot 245. The slot 245 is connected to interface with a looped end 255 of a basket driver rod 250. The basket drive rod 250 is a longitudinal structure that can translate the motion of the trigger member to the doors 105, 110. Looped end 255 includes a curvature that interfaces with the slot end 245 of the trigger member 230 such that if the trigger member 230 is deflected downwardly, the slot end 245 will translate this downward deflection to the basket drive rod 250. Conversely, the basket driver rod 250 interfaces with the slot end 245 of the trigger member 230 such that if the trigger member 230 is deflected upwardly, the slot end 245 will also translate this upward movement to the basket drive rod 250 as well. It should be appreciated that this embodiment is only illustrative and the arrangement may be reversed with the basket drive rod 250 including the slot end 245 and the trigger member 230 including a looped member 255. Various connection configurations are possible and the trigger member 230 may be integrally connected to the basket drive rod 250 or connected by any manner known in the art.

The trigger member 230 also has an extended trigger portion 260. The extended trigger portion 260 is a thin resilient surface that serves as the support 170 in FIGS. 1 through 3. The extended trigger portion 260 extends through the channel 210 or opening disposed through the second handle housing portion 205. As shown, the extended trigger portion 260 includes surfaces that are rounded and smooth as these surfaces contact the user's palm to control the movement and pivoting of the trigger member 230. In this manner, the user may support the trigger member 230 by the extended trigger portion 260 through the channel 210 of the second handle housing portion 205 and simply by gripping handle 120.

Moreover, the user may selectively control the speed of the pivoting of the trigger member 230 about pivot 230b by supporting the extended trigger portion 260 through the slot 210 of the second handle housing portion 205. The user may desire to simply loosen the grip on the handle 120 to slowly permit the trigger member 230 to pivot about pivot 230b and to translate this motion to the basket drive rod 250 to open or close doors 105, 110.

Disposed on a top side of the trigger member 230 is the hooked member 150 which interfaces with a slot 150′ disposed through the top of the first handle housing portion 200. In this manner, the user may affix or otherwise connect the hooked member 150 through the slot 150′ and hook the hooked member 150 to the first handle housing portion 200. This connection couples the trigger member 230 to the first handle housing portion 200 and keeps the trigger member 230 in place to keep the basket doors 105, 110 in the closed position.

The basket drive rod 250 is a lightweight, rigid member. Now referring to the opposite end, the basket driver rod 250 further is directly connected to a basket slider portion 265 at end 265′. The basket slider 265 is connected to the doors 105, 110 and is intended to push the basket doors 105, 110 opened, or pull the basket doors 105, 110 closed. The basket slider 265 is connected to the drive rod 250 and may move upwardly or downwardly in response to the pivoting of the trigger member 230 in between the first handle housing 200 and the second handle housing 205.

The basket slider 265 includes a first finger 265a and a second finger 265b that together form a substantially upside down U shaped member. The first finger 265a is a resilient member and includes an aperture 270. The second finger 265b is also a resilient member and includes a second aperture 275. The first finger 265a and the second finger 265b preferably deflect in a downward manner in order to open the basket doors 105, 110.

The first door 105 includes a first tab 105a with a receiving aperture that connects with a first pivot pin 105a′ on the basket 115. The first door 105 also includes a second tab 105b with a receiving aperture that connects with a pivot pin 105b′ on the basket 115. The first door 105 further includes a looped member 105c. The looped member 105c is a resilient, curved bar like structure and extends from the first tab 105a to the first door 105. The looped member 105c also extends through the first aperture 270 of the basket slider 265, or from the finger 265a thereof. In this manner, the basket slider 265 is connected to the first door 105 by the first looped member 105c and through the first finger 265a. Likewise, the second door 110 includes a first tab 110a with a receiving aperture that connects with a pivot pin 10a′ on the basket 115. The door 110 also includes a tab 110b with a receiving aperture that connects with a pivot pin 10b′ on the basket 115. The first door 105 further includes a looped member 110c that extends from the tab 110a. The looped member 110c also extends through the aperture 275 of the basket slider 265, or from the finger 265b thereof. In this manner, the basket slider 260 is connected to second door 110 by the first looped member 110c through the other finger 265b. It should be appreciated that the tabs 110a, 105a may be configured with other connection devices.

Upon being deflected downwardly from the basket drive rod 250, the basket slider 265 translates downwardly in a similar manner, and forces the first door 105 and the second door 110 to rotate open. Likewise, when the basket slider 265 is moved upwardly, the basket slider 265 translates upwardly. This upward movement moves the looped members 105c, 110c upwardly to pivot the doors 105, 110 and close the doors 105, 110.

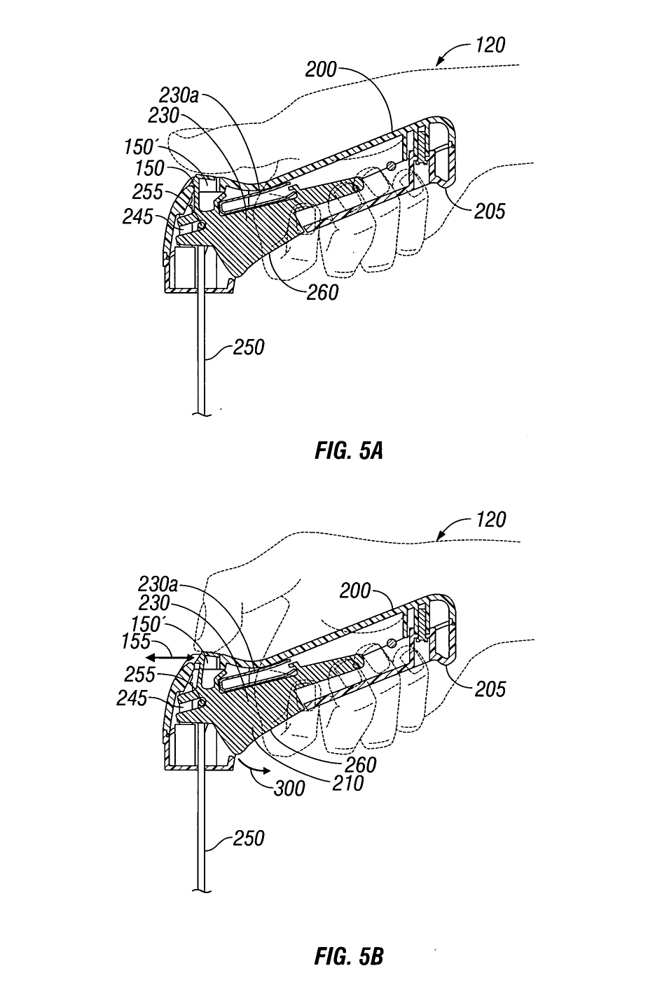

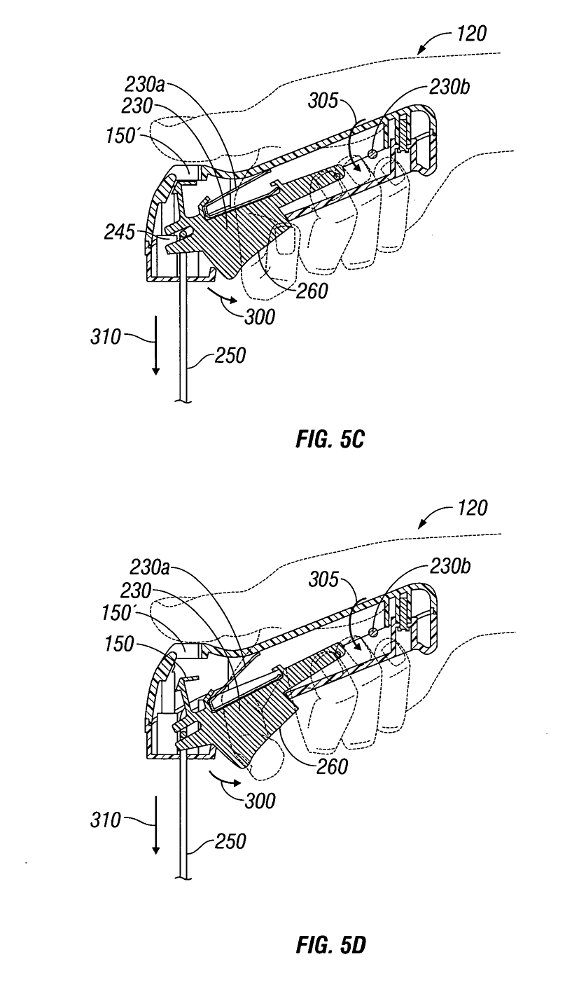

Turning now to FIGS. 5A through 5D, operation of the fryer basket 100 is shown and described commencing with operation of the handle 120. As shown in FIG. 5A, the hook member 150 of the trigger member 230 is positioned through slot 150′. The hook member 150 holds the trigger member 230 and supports it on the first handle housing portion 200. This hook member 150 otherwise also supports the basket drive rod 250 in a first position as the trigger member 230 is held stationary between the first handle portion 200 and the second handle portion 205. Here, the basket drive rod 250 is connected in the slot 245 of the trigger member 230 by looped end and is held in the retracted or first position.

Turning now to FIG. 5B, when the user desires to release the contents of the basket 115, the user will separate or detach the hook member 150 from the first handle portion 200 or slot 150′. The user advances the hook member 150 in a direction that is parallel to a longitudinal axis 160 of the handle 120 as shown by arrow 155. In this manner, without the support from the hooked member 150, the trigger member 230 drops and rotates about pivot 230 as shown by reference arrow 300. In this detached position as shown in FIG. 5B, the user can support the trigger member 230 by supporting underneath the extended portion 260 with the palm as shown. The extended portion 260 extends through the channel 210 and the user by lifting the extended portion 260 may control basket driver rod 250 that extends through the second handle housing 205.

Turning now to FIGS. 5C and 5D, when the user desires to open the first basket door 105 and the second basket door 110, the user may simply release the extension member 260 using the user's palm the appropriate amount as shown by arrow 300. This release permits the trigger member 230 to pivot about the pivot end 230b in a direction downwardly about the pivot 230b as shown by reference arrow 300. This permits the slot end 145 of the trigger member 230 to move the basket drive rod 250 in a downward manner as shown by arrow 310. The basket drive rod 250 may then be advanced in a downward manner to contact the basket slider 260 as discussed further herein.

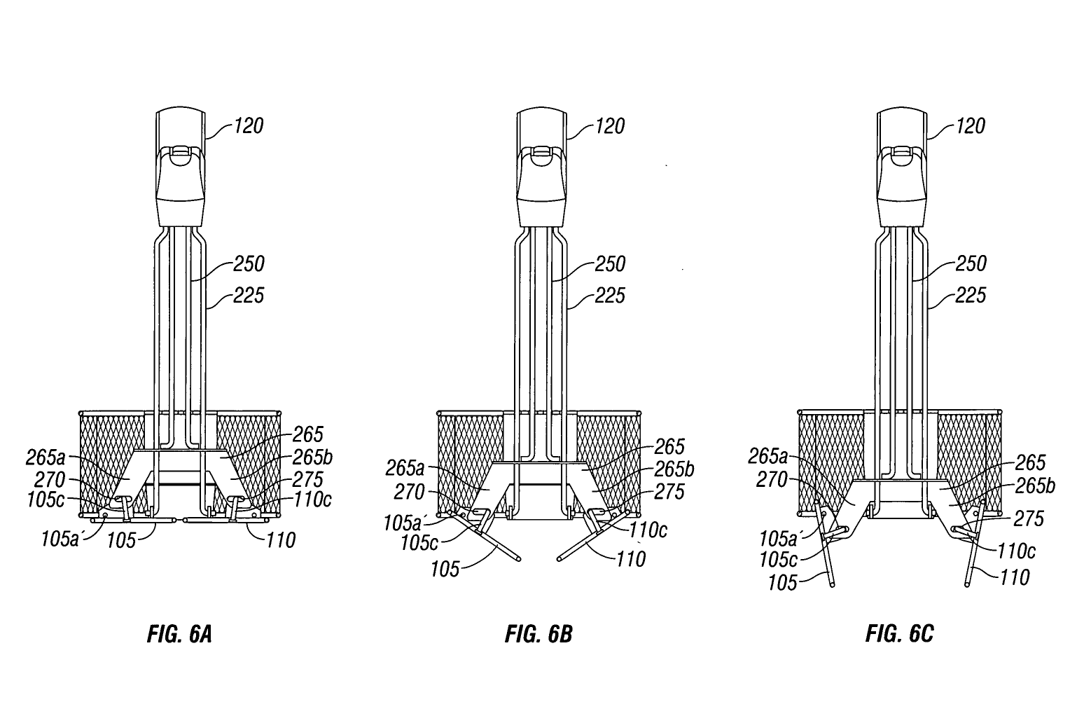

Turning now to FIGS. 6A through 6C, there is shown the advancement of the basket drive rod 250 from the closed to the open positions. The basket drive rod 250 is moved in a downward fashion by the trigger member 230, or slot 245 that moves the basket drive rod 250 downwardly. The basket drive rod 250 then moves the basket slider 265 in a similar manner or downwardly. The basket slider 265 connected to the first and the second fingers 265a, 265b will likewise move in a downward manner. The first and second fingers 265a, 265b include the respective first aperture 270 and the second aperture 275 which are each connected to the first and the second basket doors 105, 110 by the respective looped members 105c, 110c. The basket slider fingers 265a, 265b contact the respective first looped member 105c and the second looped member 110c to force the first basket door 105 and the second basket door 110 downwardly.

In response, the first door 105 pivots about the first pin 105a′ and the second pin (not shown) and the second basket door 110 pivots about the first pin 10a′ and second pin (not shown) to open to drop the contents through a bottom 125 of the fryer basket 100. This permits the user to controllably and correctly position the contents on a plate or other serving basket. It should also be appreciated that the basket doors 105, 110 are configured to remain closed at all times during frying or near the deep fat fryer so as not to lose the contents of the basket 115 while cooking. Moreover, hooked member 150 is configured to prevent the doors 105, 110 from opening.

In another embodiment of the present disclosure, the fryer basket 100 may be configured with one basket door, rather than two doors 105, 110, and it also should be appreciated that in a further embodiment, the trigger member 230 may be configured to slide instead of pivot in order to advance the basket drive rod 250 from the handle 120. In another alternative embodiment, the doors 105, 110 may be positioned in other locations as compared to the bottom of the basket 115, such as for example, the doors 105, 110 placed on a lateral side of the basket 115. Various configurations are possible and within the scope of the present disclosure.

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus comprising:
a basket body;
a basket door having a pivot mechanism for attaching the door to a bottom portion of the basket body, the basket door being pivotable between an open position and a closed position;
a basket slider connected to the basket door;
a handle having a handle housing and comprising a trigger member in the handle housing, the trigger member having a pivot end and a slot at an opposite end; and
a basket drive rod having a first end and a second end, the first end connecting to the basket slider and the second end slidably engaging the slot of the trigger member;
when in operation, pivoting of the trigger member about the trigger pivot end translates the basket drive rod with the translation moving the basket slider, the basket slider moving the basket door between an open and a closed position.

2. The apparatus of claim 1, further comprising a second basket door having a pivot mechanism for attaching the second basket door to the bottom portion of the basket body, the second basket door being pivotal between the open position and the closed position.

3. The apparatus of claim 2, wherein the basket slider further comprises at least two fingers at the second end of the basket drive rod, the at least two fingers moving the respective basket doors between the open position and the closed positions.

4. The apparatus of claim 1, wherein the trigger member further comprises a hook configured to detachably connect with the handle housing at the slot end.

5. The apparatus of claim 1, wherein the basket door comprises a looped ring configured to engage an aperture in the basket slider, wherein when the basket slider is translated upward or downward, the looped ring connected to the basket slider through the aperture is translated upward or downward to rotate the basket door about the pivot mechanism, to close or open the basket door, respectively.

6. The apparatus of claim 5, further comprising a second basket door comprises a second looped ring configured to engage a second aperture in the basket slider, wherein when the basket slider is translated upward or downward, the second looped ring connected to the basket slider through the second aperture is translated upward or downward to rotate the second basket door about a pivot mechanism, to close or open the second basket door, respectively.

7. The apparatus of claim 1, wherein the basket body is generally rectangular shaped.

8. The apparatus of claim 1, wherein the basket body is generally circular shaped.

9. The apparatus of claim 4, wherein when detached the hook is adapted to release the trigger member from the handle housing to allow the trigger member to move about the trigger pivot end.

10. The apparatus of claim 9, wherein the trigger member has a bottom surface extending through a bottom of the handle housing, and wherein when the hook detaches from the handle housing, the bottom surface is configured as a palm support surface to provide support and configured to control the pivoting of the trigger member about the trigger pivot end.

11. The apparatus of claim 1, further comprising a spring biasing the trigger member relative to the handle housing.

12. The apparatus of claim 1, further comprising an elongated member connecting the handle housing and the basket body.

13. An apparatus comprising:
a basket body;
a first basket door having a first pivot mechanism for attaching the first basket door to a bottom portion of the basket body, the first basket door being pivotal between an open position and a closed position;
a second basket door having a second pivot mechanism for attaching the second basket door to the bottom portion, the second basket door being pivotal between an open position and a closed position;
a basket slider connected to the basket door, the basket slider comprising a first finger and a second finger;
a handle having a handle housing and comprising a trigger member associated with the housing, the trigger member having a pivot end and a slot at an opposite end; and
a basket drive rod having a first end and a second end, the first end connecting to the basket slider and the second end slidably engaging the slot of the trigger member;
when in operation, pivoting of the trigger member about the trigger pivot end translates the basket drive rod with the translation moving the first finger and the second finger of the basket slider, the first finger moving the first basket door between the open and the closed position, and the second finger moving the second basket door between the open and the closed position.

14. The apparatus of claim 13, wherein at least one of the first basket door and the first finger include a first looped ring and an aperture, the first looped ring connected to the aperture and configured to open the first basket door upon being translated downwardly.

15. The apparatus of claim 14, wherein at least one of the second basket door and the second finger include a second looped ring and a second aperture, the second looped ring being connected to the second aperture and configured to open the second basket door upon being translated downwardly.

16. The apparatus of claim 13, wherein the trigger member includes an extended portion that extends through a slot in a bottom of the handle housing.

17. The apparatus of claim 16, wherein the trigger member further comprises a hook that is disposed opposite the extended portion with the hook configured to detachably connect with a top of the handle housing.

18. The apparatus of claim 13, wherein the basket body and the first and second basket doors are made from the same material.

19. The apparatus of claim 13, wherein at least one of the basket body and the first and second basket doors are made from a mesh material.

20. An apparatus comprising:
a basket body comprising side walls that define a top-to-bottom through opening;
a pair of basket doors, each door having a pivot mechanism for attaching the door to a respective bottom portion of the basket body, the doors pivotable between open and closed positions;
an elongated member having first and second ends, the first end connecting to the basket body;
a handle having a housing connecting to the second end of the elongated member and a trigger member disposed within the housing, the trigger member having a pivot at one end and a slot at an opposite end;
a basket slider having a pair of fingers, each finger connecting to a respective door;
a basket drive rod having first and second ends, the first end connecting to the basket slider and the second end slidably engaging the slot of the trigger member;
when in operation, pivoting of the trigger member about the trigger pivot translates the drive rod to travel within the basket opening with corresponding translation of the slider fingers to pivot the doors between open and closed positions.

21. An apparatus comprising:
a basket door having a pivot mechanism for attaching the door to a bottom portion of a basket body, the basket door being pivotable between an open position and a closed position; and
a handle having a device for opening and closing the basket door.

22. The apparatus of claim 21, wherein the device is positioned in the handle and is configured to control an amount by which the basket door opens or closes.

23. A method for cooking comprising:
inserting food into a basket;
inserting the basket into heated oil in a deep fat fryer to cook the food;
lifting the basket from the heated oil; and
ejecting the cooked food through a basket door by operation of a door control mechanism in a handle connected to the basket.
